(19) United States
(12) Patent Application Publication
(10) Pub. No.: US 2006/0012165 A1
(43) Pub. Date: Jan. 19, 2006

(54) Modular connection system

(75) Inventors: Robert D. Brockway, Bedford, NH (US); Russ St. Amand, New Boston, NH (US)

Correspondence Address: BOURQUE & ASSOCIATES, P.A., 835 HANOVER STREET, SUITE 303, MANCHESTER, NH, 03104, US

(73) Assignee: NPC, Inc., Milford, NH (US)

(21) Appl. No.: 11/184,056

(22) Filed: Jul. 18, 2005

Related U.S. Application Data
(60) Provisional application No. 60/588,857, filed on Jul. 16, 2004.
(60) Provisional application No. 60/667,000, filed on Mar. 31, 2005.

(51) Int. Cl. F16L 5/00

(52) U.S. Cl. 285/139.3

(57) ABSTRACT

A modular connection assembly features an insert secured within an aperture of a wall of a manhole and includes a first cavity having a threaded region. An adapter includes a second cavity and a first end having a threaded region for engaging the threaded region of the insert. A second end of the adapter is adapted to be secured to a pipe end. According to one embodiment, a boot connects the adapter to the pipe. The second end of the adapter includes a circumferential shoulder that biases a circumferential lip of the boot against the wall. Alternatively, the boot is secured to the adapter using adhesives or clamps. A knockout is secured to the insert and includes an internal membrane region and an exterior membrane region having a protrusion extending generally outwardly beyond the internal membrane region.

This application is a continuation of U.S. Provisional Patent Application Nos. 60/588,857 filed Jul. 16, 2004 and 60/667,000 filed Mar. 31, 2005 entitled Modular Connection System.

### TECHNICAL FIELD

The present invention relates to pipe connections and more particularly, relates to a modular pipe connection system and method.

### BACKGROUND

There currently exist many devices for connecting a pipe to an opening in a concrete structure such as a tank, manhole, or utility vault. One category of these known devices are expanded-in-place (EIP) systems that include a rubber boot having an expandable band at one end creating a seal between the rubber boot and the structure and a contractible band at the other end of the to be connected. These known EIP devices have several limitations.

For example, structures such as septic tanks and utility vaults are often manufactured with pre-configured connection points, i.e., the pipe connections leading into and out of the structures are often the same. In order to reduce the manufacturing and installation costs of these structures, it is desirable to be able to produce them having a plurality of predefined and arranged openings within the structure in order to facilitate the pipe connection.

Traditional EIP connection systems cannot be installed during the manufacturing process when the structure is cast in the forms. As a result the known EIP connection systems must be installed in the production facility or in the field. This requires a hole/opening to be drilled or cast within the structure during the manufacturing process or in the field which can increase labor costs and introduce installation problems due to installer error and varying level of skill and experience.

Moreover, known EIP connection systems are intended only two make a connection between the structure and a pipe and cannot easily form a plug. Consequently, if a structure with openings already in place is manufactured and not all the openings are utilized, the known connection systems cannot effectively be used to plug the opening in the structure. This creates a further impediment to creating a structure with openings already in place. As a result, each structure must be individually designed in order to create the desired number and arrangement of openings (thereby increasing labor costs and production times) or individually created after the structure has been manufactured (thereby increasing the labor and installation costs).

Another feature of known EIP connection systems is the use of expandable bands. Because of the moving parts and the overall complexity of the expandable bands, they are expensive to manufacture, thus increasing the overall price of the connection system. In order for the expandable band to create sufficient expansion pressure to seal between the boot and the opening of the structure, the expandable band must be made of a relatively heavy gauge, non-corrosive material such as stainless steel, thus further increasing the costs.

Accordingly, it is desirable to have a connection system that can be molded or cast in place in concrete during the manufacture of the structure, thereby reducing the manufacturing and installation costs of the connection system. The connection system should preferably be able to be made watertight and effectively form a plug in the event that an opening is not utilized. Additionally, the connection system should be less expensively produced than known EIP connection systems.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a modular connection assembly for use with an aperture in wall of a structure. The modular connection kit includes an insert defining a first cavity having a generally circular inner surface and a first threaded region. The first threaded region optionally includes substantially only a single thread, preferably extending approximately 350 degrees about the generally circular inner surface of the cavity. The insert further includes an outer, exterior surface adapted to be secured within the aperture of the structure's wall. In the preferred embodiment, the exterior surface of the insert includes at least one protrusion, for example, at least one dove-tail. Alternatively, the exterior surface of the insert includes at least one indentation.

The modular connection kit optionally includes an adapter. The adapter has an exterior surface including a second threaded region disposed proximate a first end and a second cavity having a diameter at least as large as an internal diameter of a first pipe end. The second threaded region is sized and shaped to releaseably engage with the first threaded of the insert. An interior surface of the second cavity preferably includes at least one notch adapted to engage with an internal wrench.

According to one embodiment, the adapter includes a circumferential protrusion extending generally outward from a second, generally opposite end of the adapter and generally perpendicular to a longitudinal axis of the adapter. Optionally, a gasket is sized and shaped to fit between the circumferential protrusion of the adapter and the wall of the structure.

The kit may further include a generally circular shaped cap for sealing the second cavity. The cap includes a circumferential lip extending generally inward from an outer lip region of the cap and generally perpendicular to a longitudinal axis of the cap such that at least a portion of the circumferential lip is sized and shaped to fit between the circumferential protrusion of the adapter and an exterior surface of the wall of the support. The cap may also include a central tab region adapted to form an opening sized and shaped to frictionally engage an outer surface of the first pipe end.

According to another embodiment, the adapter may include one or more grommets circumferentially disposed along the second cavity. T grommets are sized and shaped to frictionally engage an outer surface of the first pipe end. Alternatively, the kit may include a boot. The boot includes a first end adapted to be secured to the first pipe end and a second end having means for connecting the second end of the boot to a second end of the adapter.

One embodiment of the means for connecting the second end of the boot to a second end of the adapter according to the present invention features at least one protrusion disposed about the outer, exterior surface proximate the second end of the adapter and at least one indentation disposed on an inner surface proximate the second end of the boot. The protrusion and the indentation are adapted to matedly engage with each other when the second end of the boot is arranged about the second end of the adapter. An adhesive is optionally disposed between the protrusion and the indentation when the protrusion and the indentation are connected.

Alternatively, the means for connecting the second end of the boot to the adapter includes at least one indentation disposed about the outer, exterior surface proximate the second end of the adapter and at least one protrusion disposed on an inner surface proximate the second end of the boot. The protrusion and the indentation are adapted to matedly engage with each other when the second end of the boot is arranged about the second end of the adapter. Optionally, a press fit band is sized and shaped to fit about an exterior surface of the boot proximate the protrusion and the indentation that biases the boot against exterior surface of the adapter.

According to yet another embodiment, the means for connecting the second end of the boot to the adapter includes a circumferential protrusion extending generally outward from a second end of the adapter and generally perpendicular to a longitudinal axis of the adapter and a circumferential lip extending generally inward from a second end of the boot and generally perpendicular to a longitudinal axis of the boot. At least a portion of the circumferential lip is sized and shaped to fit between the circumferential protrusion of the adapter and an exterior surface of the wall of the support. Optionally, the wall of the structure includes a circumferential indentation disposed within the exterior surface of the wall proximate the aperture. The circumferential lip and the circumferential protrusion are sized and shaped to at least partially fit within the circumferential indentation.

The present invention may also feature a knockout for protecting the threads of insert during fabrication of the structure. The knockout includes a body having a generally circular outer surface sized and shaped to fit within the cavity of the insert. The body also includes an internal knockout membrane region and an exterior knockout membrane region having a protrusion extending generally outwardly beyond the internal knockout membrane region along a longitudinal axis of knockout.

The knockout optionally includes means for engaging the cavity of the insert. According to one embodiment, the means for engaging the cavity of the insert includes at least one thread that engages the threaded region of the insert. Alternatively, the means for engaging the cavity of the insert includes a snap-fit connection or a friction-fit connection.

The modular connection system may include a mandrel. The mandrel has a threaded central region for mating with a concrete form and a shoulder region over which the insert is placed to form a snap-fit connection. Optionally, the mandrel includes a slightly non-90 degree region that creates a corresponding slanted recess in the wall of the structure.

### DESCRIPTION OF THE DRAWINGS

These and other features and advantages of the present invention will be better understood by reading the following detailed description, taken together with the drawings wherein:

FIG. 1A is an exploded view of the modular connection system according to one embodiment of the present invention;

FIG. 1B partial view of one embodiment of the modular connection system according to the present invention with standard rubber pipe to manhole connector attached to plastic portion using a hose clamp or other clamping means;

FIG. 2 is a partial view of the insert as shown in FIG. 1A according to one embodiment of the present invention;

FIG. 3A is a partial view of one embodiment of the plug shown in FIG. 1A according to the present invention;

FIG. 3B is a cross section view of the plug shown in FIG. 3A inserted in the insert shown in FIG. 1A according to one embodiment of the present invention;

FIG. 4 is a partial view of pipe connection member shown in FIG. 1B according to the present invention;

FIG. 5A is a cross sectional view of another embodiment of the modular pipe connection system shown in FIG. 1A having a boot connected to a pipe connection member with a band according to the present invention;

FIG. 5B is a partial view of the pipe connection member shown in FIG. 5A according to the present invention;

FIG. 5C is a partial view of the band shown in FIG. 5A according to the present invention;

FIG. 6A is a cross sectional view of another embodiment of the modular connection system shown in FIG. 1A wherein the pipe connection member includes a grommet;

FIG. 6B is a partial view of the pipe connection member shown in FIG. 6A according to the present invention;

FIG. 7 is a partial view of one embodiment of the modular connection system for use walls of various thicknesses;

FIG. 8 is a partial view of another embodiment of a modular connection system for use with walls of various thicknesses and curved surfaces;

FIGS. 9 and 10a are schematic drawings illustrating an adapter threading into an insert into concrete and holding a rubber boot in place;

FIGS. 10b and 10c are schematic drawings illustrating another embodiment of an adapter threading into an insert into concrete and holding a rubber boot in place;

FIGS. 11A and 11B are more detailed drawings of the insert of the present invention;

FIG. 12 is a more detailed drawing of the knockout used with the insert of the present invention;

FIGS. 13A and 13B are detail drawings of the mandrel used to hold the present invention place during casting;

FIGS. 14A-14E illustrate the process of using the connection system of the present invention and various component parts thereof;

FIGS. 15A and 15B are schematic drawings illustrating in greater detail the adapter of the present invention;

FIG. 16 is a schematic drawing illustrating the use of the adapter of the present invention along with a gasket and not a rubber boot;

FIG. 17 is a schematic drawing of a rubber cap in accordance with one feature of the present invention;

FIG. 18 is a schematic drawing of a stab rubber cap in accordance with another embodiment of the present invention;

FIGS. 19A and 19B are schematic drawings of a plastic or PVC and cap used with the present invention;

FIGS. 20-22 illustrate another embodiment of a cast-in-place retainer device and knock-out according to the present invention;

FIG. 23 is a perspective view of one embodiment of a mandrel and an insert disposed within a generally cylindrical wall according to one embodiment of the present invention;

FIG. 24 is a perspective view of one embodiment of the modular connection system assembled within a generally cylindrical wall according to one embodiment of the present invention;

FIG. 25 is a perspective view of one embodiment of the modular connection system shown during the manufacturing process of a wall having two mandrels;

FIG. 26 is a perspective view of another embodiment of the modular connection system shown during the manufacturing process of a wall including a single mandrel and an integral molded skirt;

FIG. 27 is a perspective view of yet another embodiment of the modular connection system shown during the manufacturing process of a wall including a knockout region and a “T” shaped protrusion;

FIG. 28 is a perspective view of a further embodiment of the modular connection system shown during the manufacturing process of a wall including a ring adapted to be secured to the insert;

FIG. 30 is a perspective view of yet a further embodiment of the modular connection system shown during the manufacturing process of a wall including an insert constructed from a generally soft plastic having an exterior surface substantially inversely corresponding to the interior threaded region; and

FIG. 30 is a perspective view of an insert having a generally conical or tapered interior surface.

### DESCRIPTION OF THE INVENTION

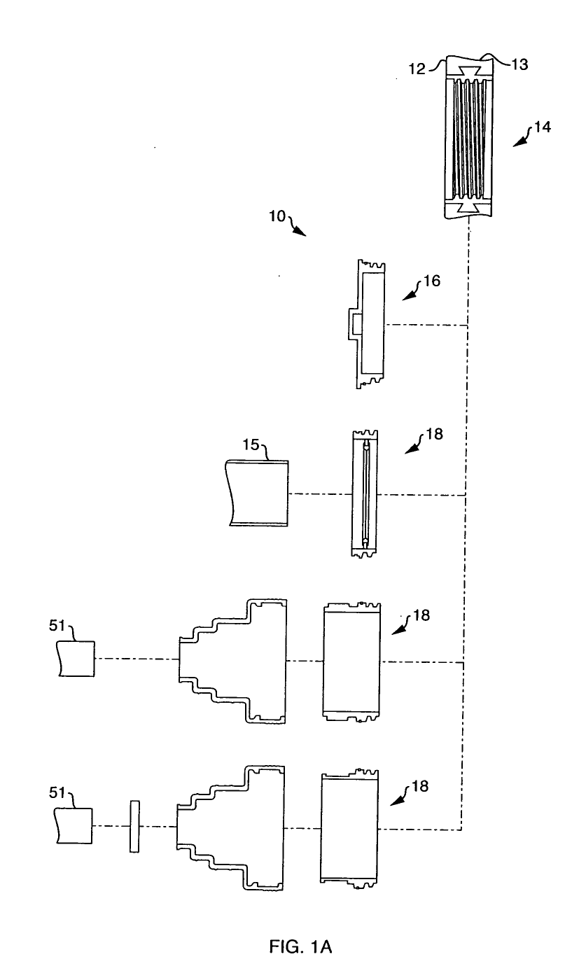

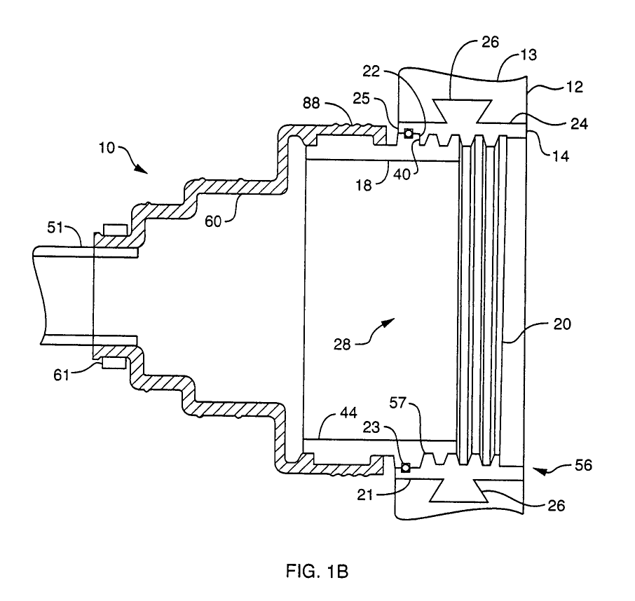

A modular connection system 10, FIG. 1A, according to one embodiment of the present invention, enables a pipe 51 to be connected to a wall 12 of a structure 13 such as, but not limited to, a concrete manhole, riser, septic tank, home or building foundation or virtually any concrete structure. According to one embodiment, the modular connection system 10 includes an insert 14 into which either a plug 16 and/or a pipe connection member 18 is threadably connected. The insert 14 is preferably constructed from a rigid plastic, though other materials having the required strength, rigidity, and chemical resistance are also contemplated. In another embodiment (not shown but within the scope of the present invention) threads may be formed directly in or on an inner circumference of a hole in a concrete structure, for interfacing directly with a plug 1 or pipe connection member 18, as described herein.

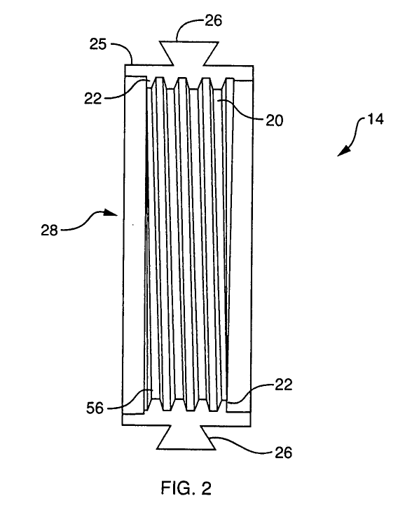

The insert 14, FIGS. 1B and 2, is molded, adhered, or otherwise secured to the surface 24 of an opening 21 in the wall 12 of the structure 13. In the exemplary embodiment, the insert 14 is molded into the wall 12 of the structure 13 during the manufacturing process of the structure 13 and preferably optionally includes one or more protrusions 26 (such as a dove tail), though as will be described in great detail hereinbelow, the modular connection system 10 may be added to the wall 12 of a structure 13 after the manufacturing of the structure 13.

The body 25 of the insert 14 forms a cavity/opening/passageway 28 having an engagement portion 56, preferably an interior threaded region 20, either male or female, though the engagement portion 56. Alternatively, the engagement portion 56 may include any other means of effecting a connection between the insert 14 and plug 16 and/or pipe connection member 18 known to those skilled in the art such as, but not limited to, a locking ring, slip ring, pressure coupling, or any other connection known to those skilled in the art or hereinafter discovered.

The body 25 preferably includes a shoulder region 22 and optionally includes a seal 23, preferably an o-ring or the like. As will be described in great detail hereinbelow, the shoulder region 22 prevents over threading of the plug 16 or pipe connection member 18. Additionally, the shoulder region 22 provides a seal between the plug 16 and/or pipe connection member 18.

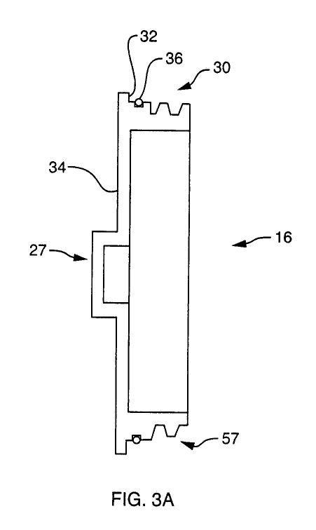

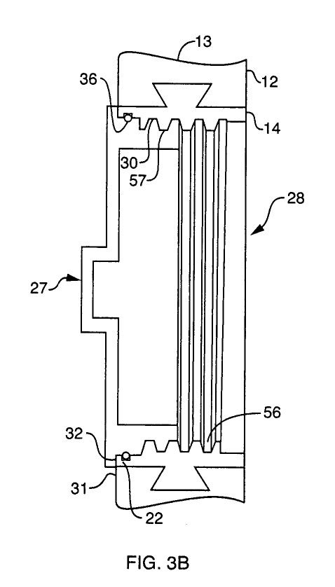

The plug 16, FIG. 3, is sized and shaped to fit within the opening 28 of the insert 14 as shown in FIG. 2 such that the wall 12 of the structure 13 is sealed. The plug 16 is particularly useful when a plurality of inserts 14 are installed during the manufacturing of the structure 13 as part of a predetermined opening 28 arrangement but remain unused in the installation or when a pipe is removed from a wall 12 of a structure 13 and the structure 13 must be sealed.

The plug 16 includes an engagement portion 57 sized and shaped to form a connection/seal with the engagement portion 56 of the insert 14. According to the preferred embodiment, the engagement portion 57 includes an externally threaded region 30 having threads corresponding to the internally threaded region 20 of the insert 14 and a wall or panel 34, though the plug 16 may include any connection known to those skilled in the art such that the plug 16 is capable of forming a connection with the insert 14. The wall or panel 34 is preferably disposed proximate an inner region of the opening 28 in the wall 12 such that the inner surface 31 of the wall 12 is substantially continuous across the opening 28. Alternatively, the wall or panel 34 may be disposed anywhere within the plug 16 such that the plug 16 forms a barrier or seal when installed.

In the preferred embodiment, the plug 16, FIG. 3, includes a shoulder region 32 having a seal 36 (preferably a rubber, silicon or other appropriate material o-ring or the like) sized and shaped to engage the shoulder region 22 of the insert 14 or alternatively, to seal directly against the inner wall of the concrete hole. Optionally, the plug 16 may include a handle or a protrusion such as a knob, head, or recess 27 to facilitate the rotation/threading of the plug 16 into the insert 14 (for example, by means of a wrench, ratchet, or by hand).

The pipe connection member 18, FIGS. 1B, 4, and 5A, allows the modular connection system 10 to create the connection/seal between the wall 12 of the structure 13 and a pipe 51. The pipe connection member 18 includes an engagement portion 58 sized and shaped to form a connection with the engagement portion 56 of the insert 14. According to the preferred embodiment, the pipe connection member 18 includes a body 49 having an externally threaded region 38 (the preferred embodiment of the engagement portion 58) sized and shaped to threadably engage the internally threaded region 20 of the insert 14. The body 49 optionally includes a shoulder region 40 that engages the shoulder region 22 of the insert 14 to prevent over threading of the pipe connection member 18 relative to the insert 14. In the exemplary embodiment, the body 49 also includes a seal 42 (preferably and o-ring or the like) to ensure a proper seal between the pipe connection member 18 in the insert 14.

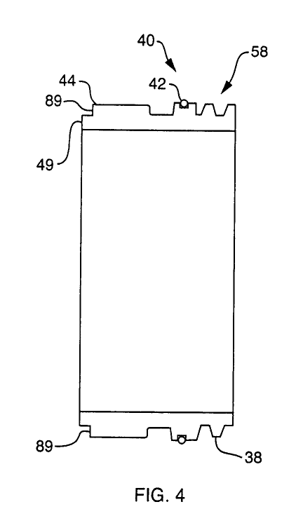

The pipe connection member 18 includes a connection section 44. According to one embodiment, the connection section 44, FIGS. 1b, 4, and 5A, is preferably formed from a rigid material (though it may also be resilient) and is sized and shaped to accept at least a portion of a boot 60. According to embodiment, the boot 60, FIG. 1b, includes a section 88 (preferably a rigid section) that engages the connection section 44 of the pipe connection member 18. In the exemplary embodiment, the connection section 44 and the section 88 of the boot 60 are joined with an adhesive or sealant. The connection section 44, FIG. 4, preferably includes one or more protrusion or ridges 89 that aid in forming a connection between the pipe connection member 18 and the boot 60 as shown in FIG. 1b.

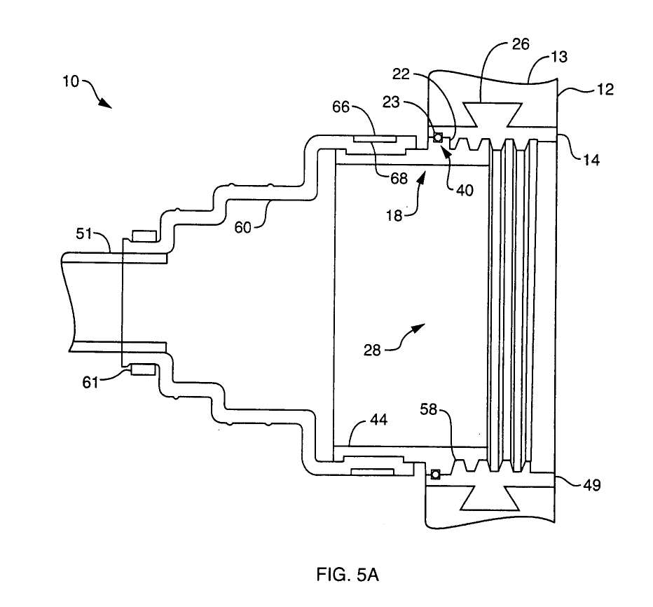

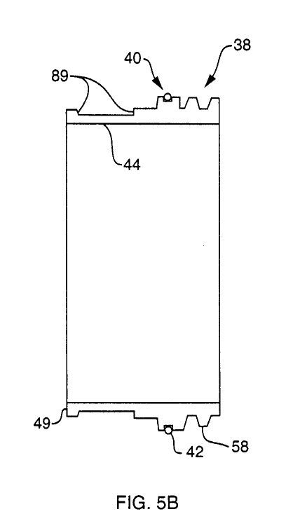

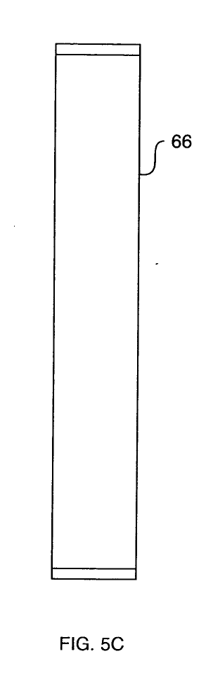

According to another embodiment, the boot 60, FIG. 5, is a resilient, traditional rubber boot. The boot 60 is disposed about the connection section 44 (preferably on the outer surface, though the boot 60 may also be secured internally) and is secured to the pipe connection member 18 with one or more press fit bands 66. The press fit band 66, FIG. 5C, is preferably formed from a rigid plastic, though other materials such as metal and the like may also be used. The press fit band 66 is sized and shaped to fit over the surface 68 (preferably the outer surface) of the boot 60 in a friction type manner. The use of plastic reduces the overall cost of the modular connection system 10. One or more ridges or protrusions 89 on the pipe connection member 18 may further aid in securing the boot 60 to the connection section 44. Additionally, a sealant or adhesive may also be used.

In either embodiment, one or more clamps 61, FIGS. 1B and 5A, such as, but not limited to, traditional band clamps, may be used to secure the other end of the boot 60 to the pipe 51. It should be noted that other devices and methods for connecting the boot 60 to the pipe 51 are also envisioned.

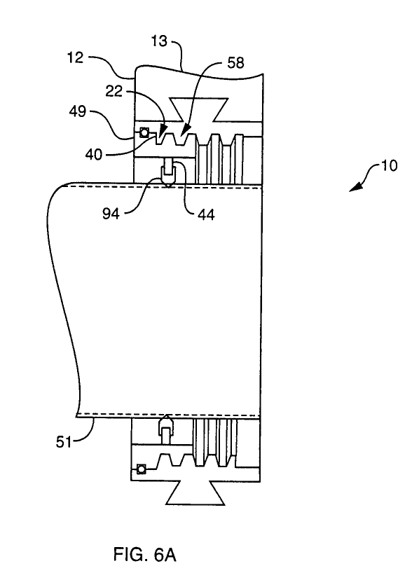

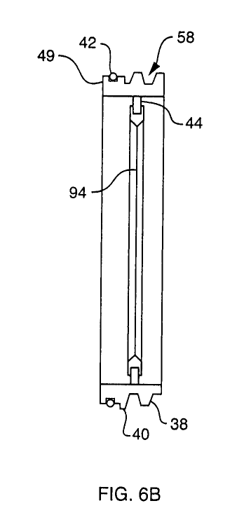

According to a further embodiment, connection section 44, FIG. 6, of the pipe connection member 18 includes one or more flexible, resilient annular grommets 94. The grommet 94 is size and shaped to frictionally engage the outer surface of the pipe 51 and preferably has an inner diameter slightly smaller than the outer diameter of the pipe 51.

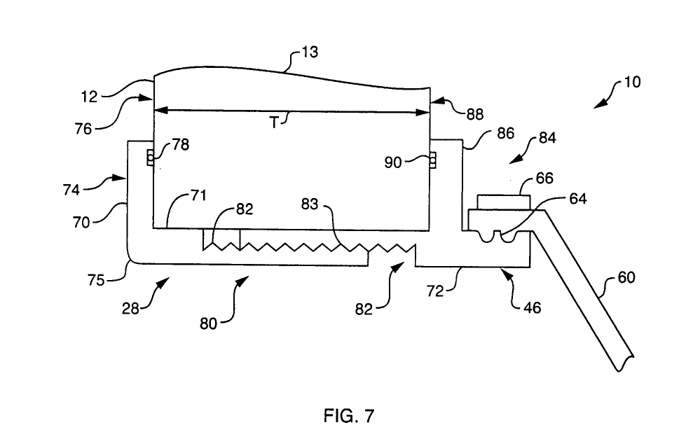

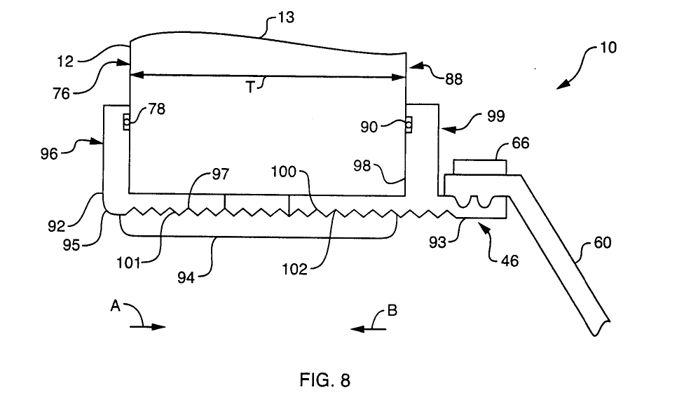

According to yet another embodiment, the modular connection system 10, FIGS. 7 and 8, is designed to fit a variety of wall 12 thicknesses T. The modular connection system 10, FIG. 7, includes a first and a second biasing portion 70, 72. The modular connection system 10, according to present embodiment, is best suited for use with walls 12 having a substantially flat or planar first and second surface 76, 88. The modular connection system 10 is also particularly useful when a connection is needed and the structure 13 does not have a preformed opening in the wall 12.

The first biasing portion 70 includes a body 71 having a first wall engagement section 74 disposed proximate a first end 75. The first wall engagement section 74 is sized and shaped to fit along a portion of a first surface 76 of the wall 12 proximate the opening 28. In the preferred embodiment, the first wall engagement section 74 also includes one or more seals 78 (preferably an o-ring or like).

The second end 80 of the first biasing portion 70 includes an engagement portion 82. The engagement portion 82 preferably includes a threaded region, though other means of connecting the first and the second biasing portion 70, 72 such as, but not limited to, a slip ring, locking ring, and a pressure coupling are also contemplated.

The second biasing portion 72 includes a first end region 82 having an engagement portion 83 sized and shaped to engage the engagement portion 82 of the first biasing portion 70. In the preferred embodiment, the engagement portion 83 includes a threaded region sized and shaped to threadably connect with the engagement portion 82 of the first biasing portion 70.

A second end region 84 of the second biasing portion 72 includes a second wall engagement portion 86 sized and shaped to engage a second surface 88 of the wall 12. According to preferred embodiment, the second wall engagement portion 86 preferably includes one or more seals 90 (preferably an o-ring or the like). The second end region 84 also preferably includes a pipe connection/seal 46 for making a connection with a boot 60 in any manner known to those skilled in the art.

The modular connection system 10 according to FIG. 8 is particularly useful with structures 13 having complex or curved first and second surfaces 76, 88, such as but not limited to, pipes, septic tanks, or manholes. The modular connection system 10 includes a first biasing portion 92, a second biasing portion 93, and a connector 94.

The first biasing portion 92 includes a body 95 having a first wall engagement section 92 sized and shaped to engage a first surface 76 of the wall 12. According to the preferred embodiment, the first wall engagement section 96 preferably includes a seal 78 as described above. The body 95 also includes an engagement portion 97 (preferably a threaded region) as described above.

The second biasing portion 93 includes a body 98 having a second wall engagement portion 99 sized and shaped to engage a second surface 88 of the wall 12 preferably includes a seal 90. The body 98 also includes an engagement portion 100 (preferably a threaded region) and a pipe connection/seal 46 for creating a connection with a boot 60 as described above.

The connector 94 is sized and shaped to bias the first and second wall engagement sections 92, 99 of the first and second biasing portion 92, 93 against the first and second wall surfaces 76, 88. The connector 94 includes at least one engagement portion 101 (preferably a threaded region) sized in shaped to engage the engagement portions 97, 100 of the first and second biasing portion 92, 93. According to preferred embodiment, the connector 94 includes a first and at least a second engagement portion 101, 102 corresponding to the engagement portions 97, 100 of the first and second biasing portion 92, 93 respectively.

In practice, the first and second biasing portion 92, 93 are placed proximate the first and second surfaces 76, 88 of the wall 12 with the connector 94 between the first and second biasing portion 92, 93. Next, the connector 94 is used to move the first and second biasing portion 92, 93 in a direction of arrows A and B, respectively, until the wall biasing engagement sections 96, 99 are biased against the first and second surfaces 76, 88 of the wall 12. In the exemplary embodiment, the connector 94 threadably moves the first and second biasing portion 92, 93.

Since only the connector 94 is rotated, the modular connection system 10 according to the present embodiment can be used when structures 13 having various thicknesses T and compound or curved first and second surfaces 76, 88.

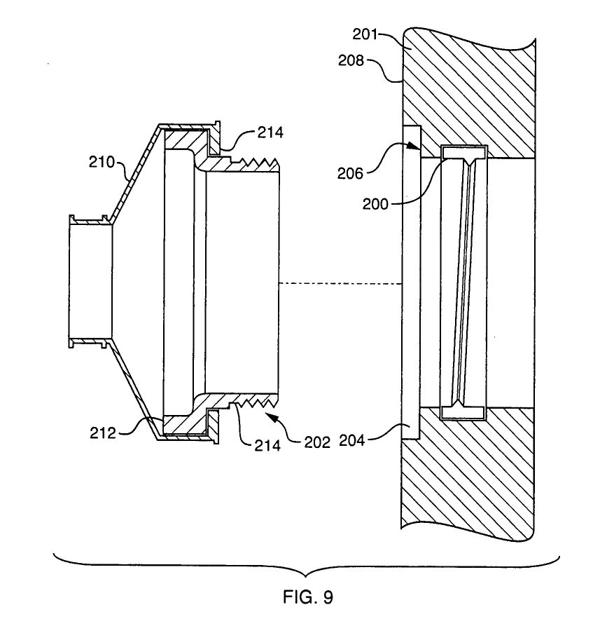

In another embodiment, the modular connections system 10, in accordance with the present invention, includes a cast in place threaded insert 200, FIG. 9, and a torquing ring or adapter 202. The threaded insert 200 is cast in place in the concrete wall or other structure 201. During the process of casting in place the insert 200, a recess 204 is created inside of the normal face 208 of the concrete wall 201. This recess includes a recessed face 206 whose use will be explained further below.

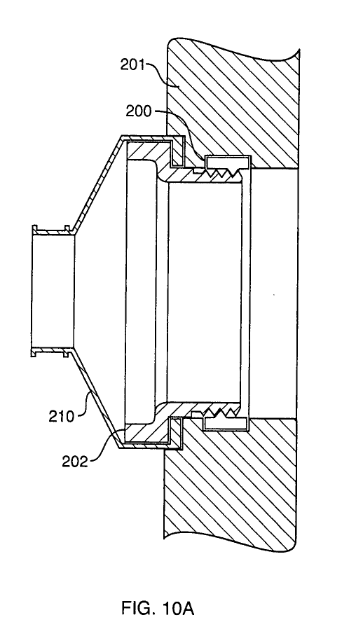

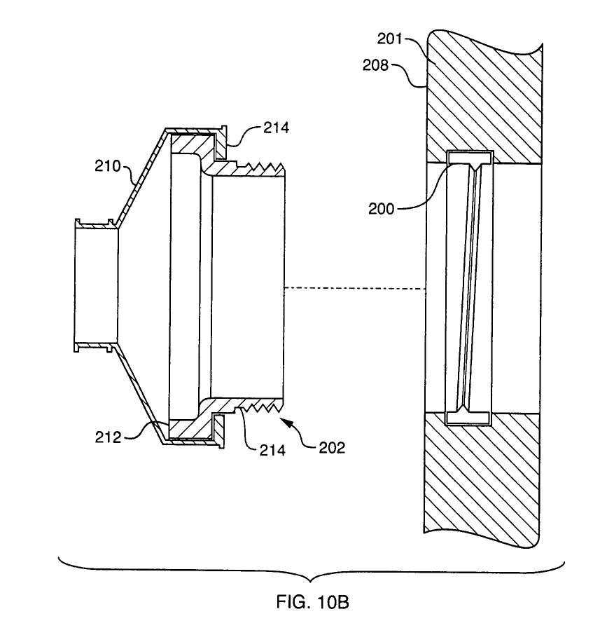

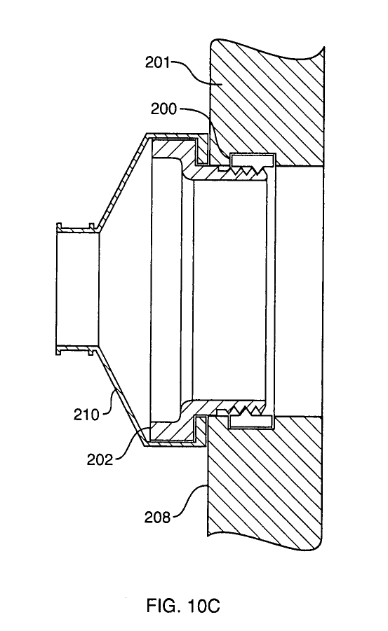

Typically, the present invention is meant to be used with a resilient rubber boot 210, although this is not a limitation of the present invention. In use, the resilient rubber boot 210 is placed over the first end 212 of the adapter 202. A portion 214 of the resilient rubber boot 210 forms a vertical surface such that when the adapter or torquing ring 202, having external threads 214 is threaded into the insert 200, FIG. 10a, the portion 214 of the resilient rubber boot 210 mates with face 206 in the concrete wall 201 forming a waterproof barrier between the adapter/insert combination and the concrete wall 201. Alternatively, the recessed 204 may be eliminated as shown in FIGS. 10b and 10c. According to this embodiment, the portion 214 of the resilient rubber boot 210 forms a vertical surface such that when the adapter or torquing ring 202, having external threads 214 is threaded into the insert 200, the portion 214 of the resilient rubber boot 210 mates with normal face 208 in the concrete wall 201. In either embodiment, the problem of how to get a watertight seal between a plastic insert and concrete is solved.

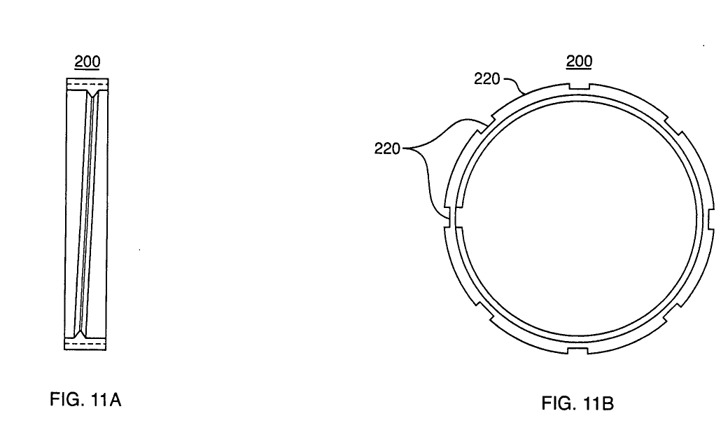

The threaded insert 200 is shown in greater detail in FIGS. 11A and 11B. The threaded insert 200 is typically formed of PVC material, approximately ¼″ thick. The insert 200 has a single thread, preferably extending approximately 350° around the inside diameter of the insert. Having a single row of thread makes the insert easy to mold and in fact a two-piece mold may be utilized wherein the part line of the mold is in a helix pattern and corresponds to the single thread row. The exterior region in 220 of the threaded insert 200 may include a plurality of notches 220 which aid to mechanically interlock the insert 200 with the concrete.

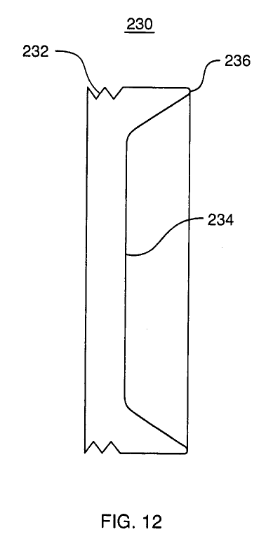

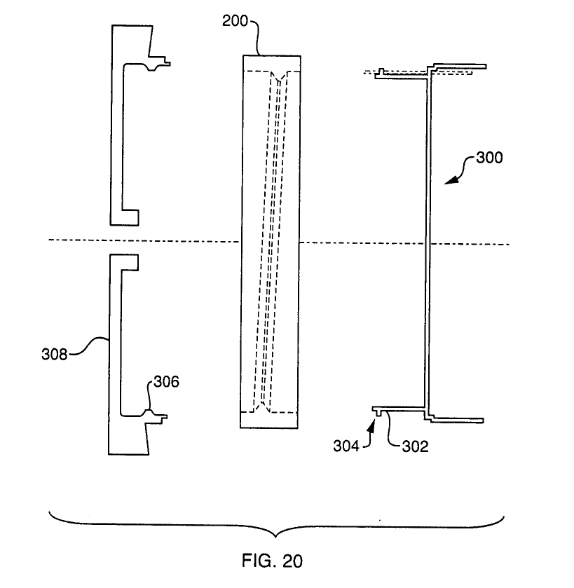

Typically, in order to protect the inner threads of the insert 200 during the casting process, an externally threaded knockout 230, FIG. 12, is utilized. The threaded knockout includes 1 or more external threads 232 and an internal knockout membrane region 234 and a thicker, protruding region 236 forming “ears” on the knockout. The knockout 230 is threaded into the insert 200 prior to casting the concrete. The protruding region 236 will create a thinner area of concrete in the area of the circumference of the protrusion, as well as a thicker central region proximate the internal knockout central region 234. The thicker central region of concrete created by the internal knockout membrane 234 facilitates using a hammer or other device to strike or impact solidly on the thicker central region while the thinner area of concrete proximate the protruding regions 236 facilitate the knockout 230, as well as a plug of concrete formed by the knockout, to be dislodged from the insert 200 and the concrete. Typically, the knockout 230 is also made of a PVC type material. Although the knockout 230 is shown and described as being “threaded” into the insert 200, this is not a limitation of the present invention since the knockout 230 may be made to “snap fit” into the insert 200 using one of more well-known techniques for interconnecting plastic parts. Alternatively, the knockout 230 may interconnect with the insert 200 by means of friction fit. An alternative knockout 300, FIGS. 20-22 is disclosed and discussed below.

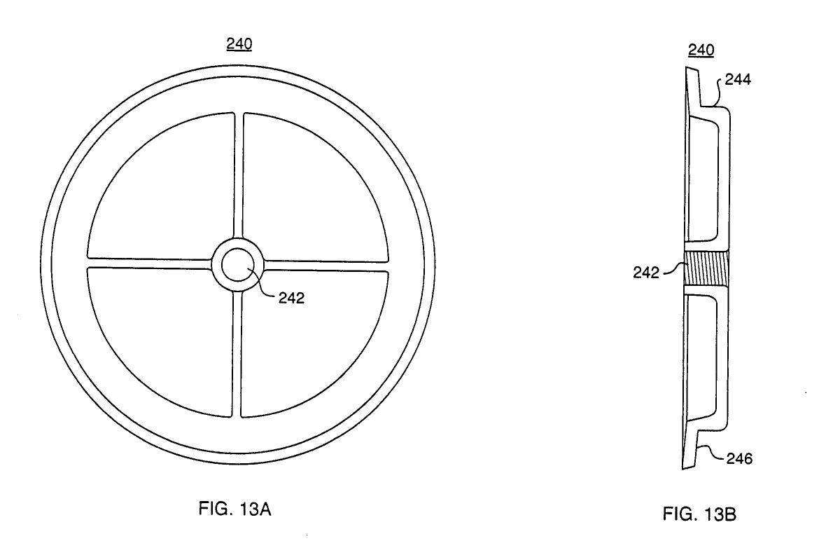

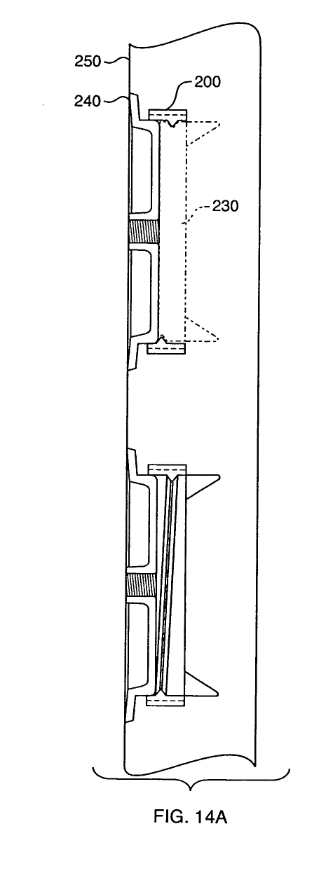

Although the insert 200, FIG. 13, and the knockout 230 may be placed alone in the concrete form, more typically, a mandrel 240, FIGS. 13A and 13B is utilized. The mandrel 240 is provided having a threaded central region 242 which mates with a bolt or other similar device inserted through a concrete form (not shown). The bolt holds the mandrel 240 to the form. The mandrel 240 also includes a slightly recessed shoulder region 244 over which the insert 200 is placed allowing the insert 200 to “snap fit” over the shoulder region 244 of the mandrel 240.

In the preferred embodiment, the mandrel 240 includes a slanted or slightly non-90° region 246 which creates a corresponding slanted recess 206 in the concrete. The inwardly slanting region 246 interact with the rubber boot forcing the rubber inwardly toward the central region of the hole rather than outwardly away from the concrete face. This helps ensure a watertight seal between the modular connections system of the present invention and the concrete.

Although the embodiments shown have a flat profile for a flat wall, they can also be made having a radius of curvature for a curved wall, such as found in a concrete manhole or the like.

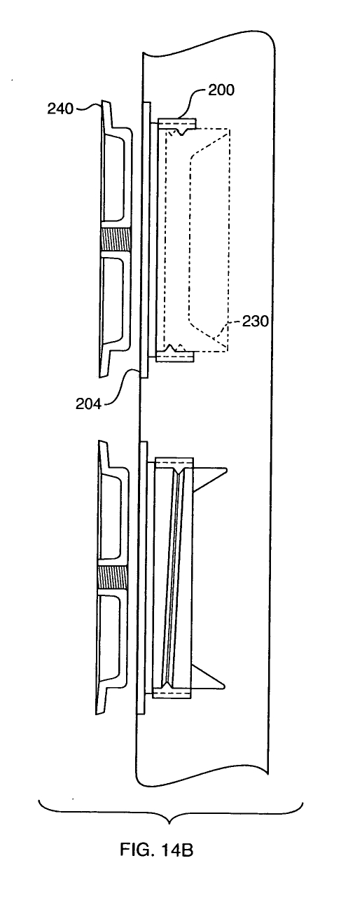

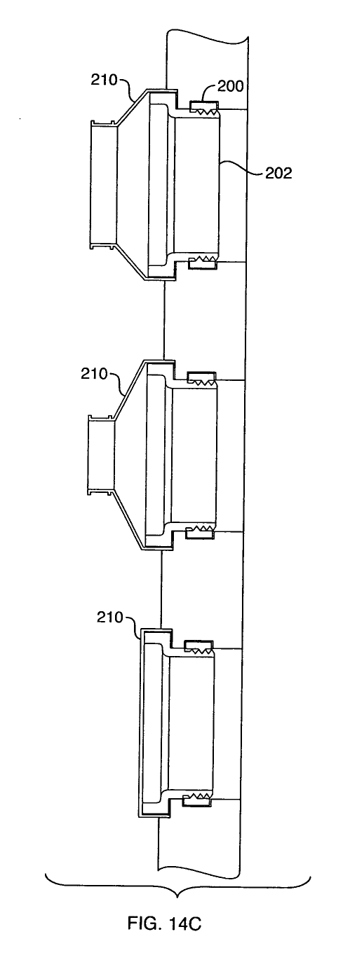

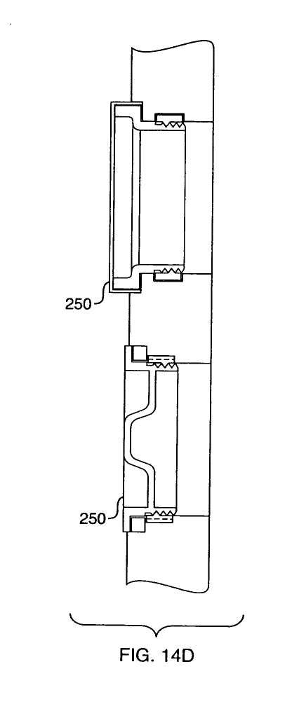

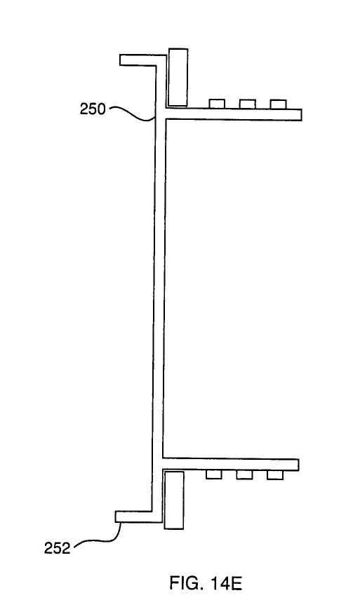

FIGS. 14A-14D illustrate the method or process of using the system of the present invention. As shown in FIG. 14A, the insert 200 including the knockout 230 is mounted onto the mandrel 240. The mandrel 240 in turn is mounted to the concrete form 250. After the concrete is cast in place, the form along with the mandrel 240 is removed leaving the insert 200 and the knockout 230 in place. As previously discussed, the mandrel 240 forms a recessed region 204 in the concrete. After the knockout is removed, FIG. 14C, the adapter or torquing ring 202 is inserted into the insert 200 with either a rubber boot 210 or a rubber cap 212. Alternatively, one or more cap's 250, FIGS. 14D and 14E may be provided. As shown in FIG. 14E, a protruding region 252 may be provided as a “brim” on which a strap wrench or other similar device may be placed to tighten and loosen the cap 250.

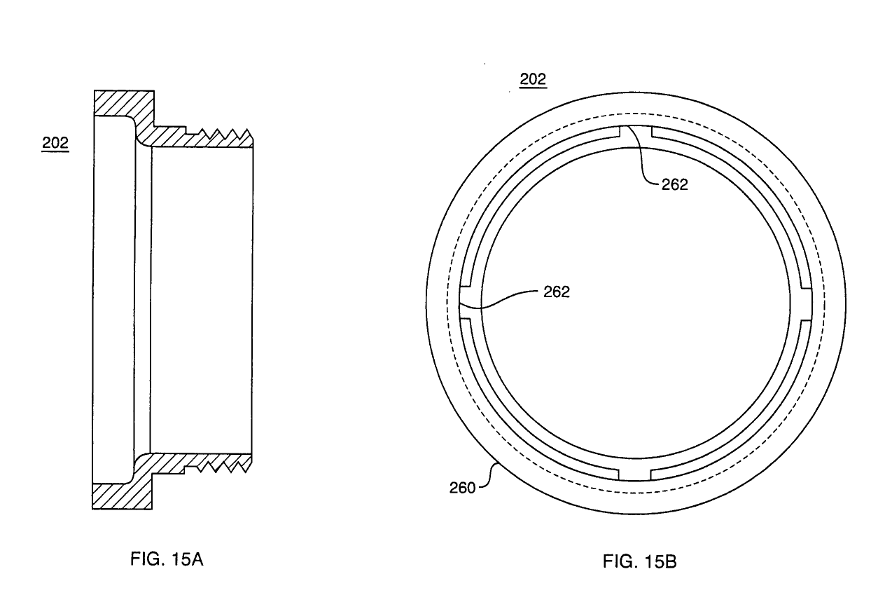

FIGS. 15A-15B illustrate the adapter or torquing ring 202 in greater detail. The exterior 260 of the torquing ring 202 may be textured so as to interlock with the rubber boot which is placed over it. It is important to note that with the construction of the adapter 202 of the present invention, no additional clamp is needed to connect the rubber boot to the adapter. In addition, the interior region of the torquing ring 202 may include one or more notches 262 which serve to allow the torquing ring 202 to be screwed into the insert 200 using an internal wrench.

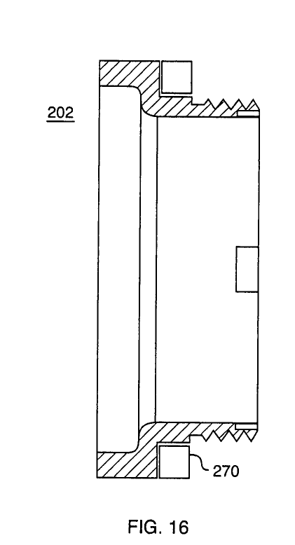

FIG. 16 illustrates the torquing ring or adapter 202 utilized not with a rubber boot but rather, with a gasket 270 which serves as a seal between the adapter 202 and the concrete.

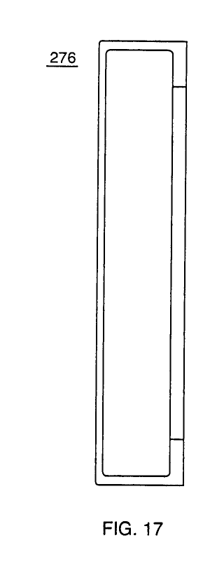

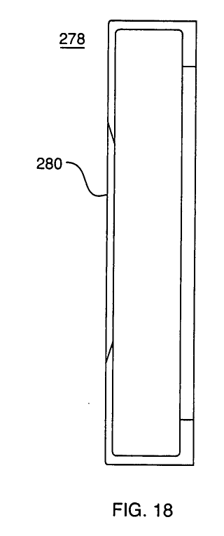

FIG. 17 illustrates a rubber cap 276 which may be used with the adapter 202 to seal a hole which is not going to be used at the present time. Similarly, FIG. 18 illustrates a rubber boot 278 which has a central “tab” region 280 allowing a pipe or other device to pierce the rubber cap 278.

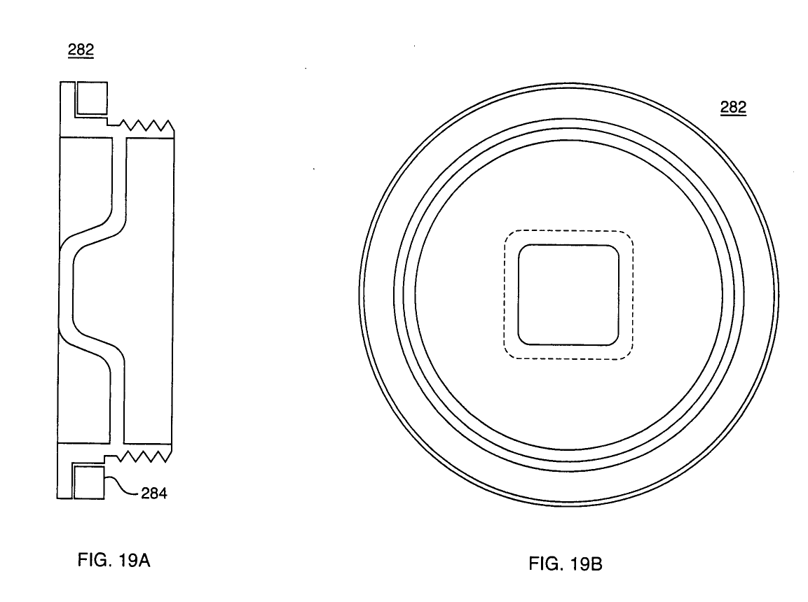

FIGS. 19A and 19B illustrate a plastic or PVC cap 282 which may be used to seal a hole by mating with an insert 200. The cap 282 is utilized with a rubber or other similar gasket 284 to provide a watertight seal against the concrete.

In another embodiment of a knockout used when casting in place a threaded insert 200 of the present invention, knockout 300, FIGS. 20-22 may be provided. The knockout 300 utilizes a number of snap fit legs or fingers 302 having a small bump or protrusion 304 proximate their distal end. The bump or protrusion 304 is adapted to mate with a bump or protrusion 306 located on the mandrel 308 which is attached to the form, as previously described.

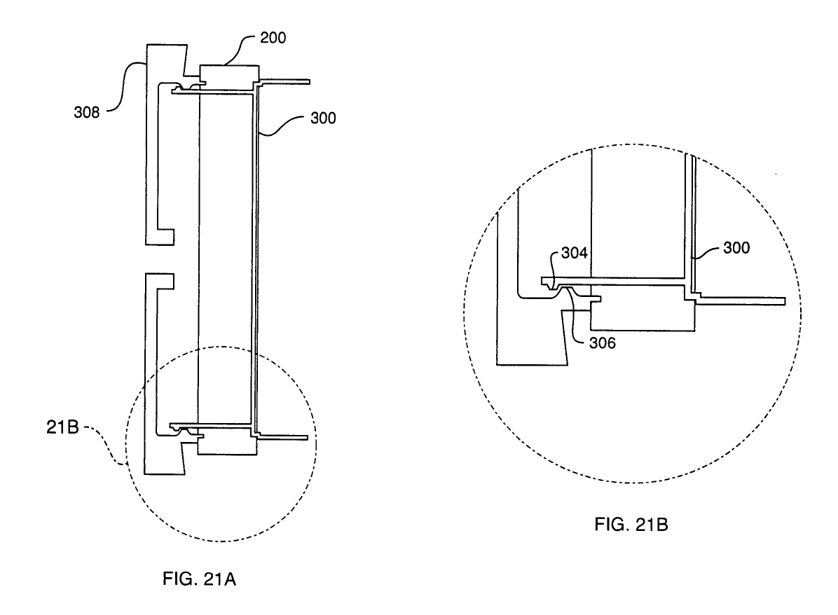

When assembled, as shown in FIG. 21, the user simply pushes on the knockout 300 with enough force to cause the protrusion 304 to slide over and interface with protrusion 306 on the mandrel 308. Only approximately 10 to 20 pounds of frictional force are required to assemble/disassemble the knockout 300 onto the mandrel 308.

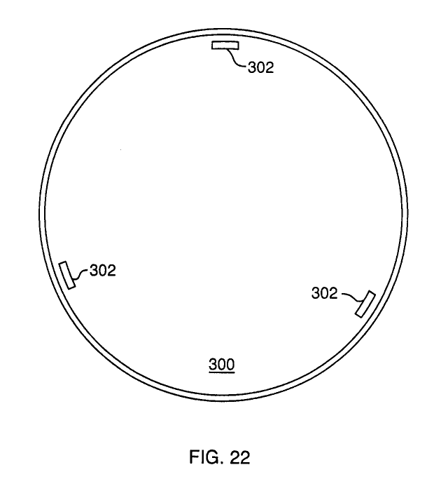

In the preferred embodiment, the knockout 300, FIG. 22, includes three snap fit legs or fingers 302, although this is not a limitation of the present invention as two or more fingers or legs 302 may be utilized, as desired. The embodiment shown in FIGS. 20-22 (as well as other embodiments disclosed herein) is particularly well suited for standard configuration situations such as septic tanks, utility vaults and foundations where many waterproof knockouts may be located and only some of them used.

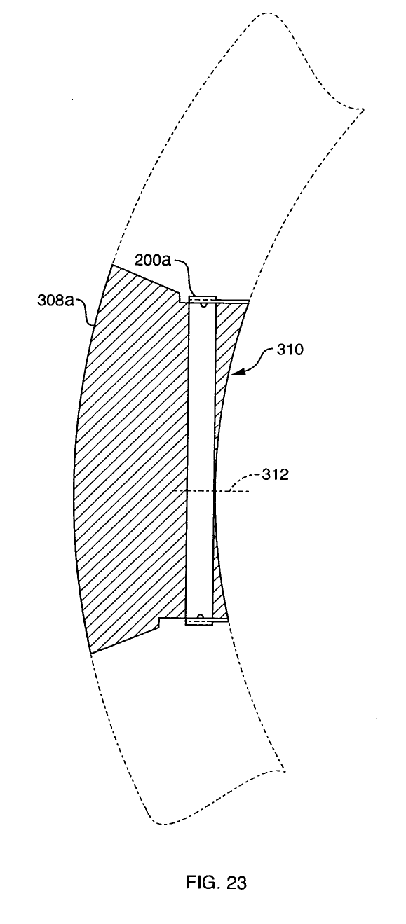

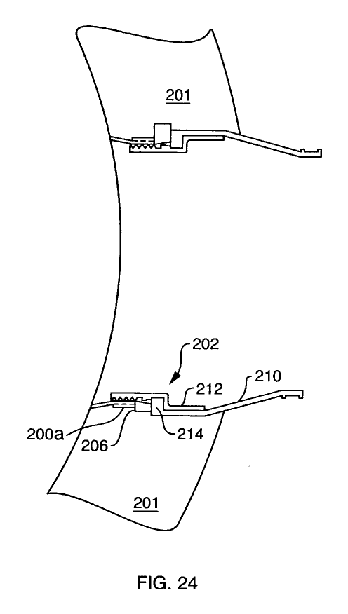

In other situations, such as manholes, the user may not want to locate so many unused knockouts but rather, may want to position openings where they will be used. The present invention may utilize a mandrel 308a, FIG. 23, mounted to the outer form used to from the manhole. Insert 200a, having a curved inner surface 310 which matches the ID of the manhole and abuts generally the inner wall form, is mounted on the mandrel using a bolt inserted through central region 312, by snapping onto the mandrel 308a, by using some magnetic device or by some other device as will be clear to those skilled in the art. Once the mandrel 308a is removed, the insert 200a remains in place, FIG. 24.

In use, the resilient rubber boot 210, FIG. 24, is placed over the first end 212 of the adapter 202. A portion 214 of the resilient rubber boot 210 forms a vertical surface such that when the adapter or torquing ring 202, having external threads 214 is threaded into the insert 200, the portion 214 of the resilient rubber boot 210 mates with face 206 in the concrete wall 201 forming a waterproof barrier between the adapter/insert combination and the concrete wall 201. In this manner, the problem of how to get a watertight seal between a plastic insert and concrete is solved.

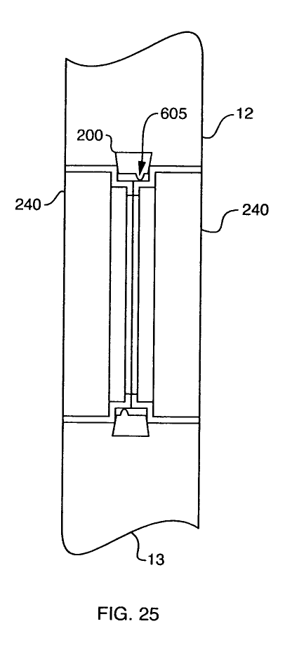

According to another embodiment, the present invention features an insert 200, FIG. 25, formed from an elastomeric material. The insert 200 is supported by a first and a second mandrel 240 disposed on an inside and outside surface of the wall 12 during the manufacturing process of the structure 13. The use of two mandrels 240 positively locates the insert 200 during the manufacturing processes of the structure 13 and prevents the concrete of the structure 13 from entering into the cavity formed by the insert 200 during the manufacturing of the structure 13 thereby eliminating the need to remove the concrete knockout/plug and protecting the threaded region of the insert 200.

In use, the insert 200 mates with an adapter, torquing ring, or the like (not shown) which creates a radial force urging the elastomeric insert 200 against the aperture formed in the wall 12 thereby sealing the connection. According to a preferred embodiment, the adapter, torquing ring, or the like has a tapered or conical shape that further biases the insert 200 against the aperture within the wall 12 once threaded in place further enhancing the mechanical seal.

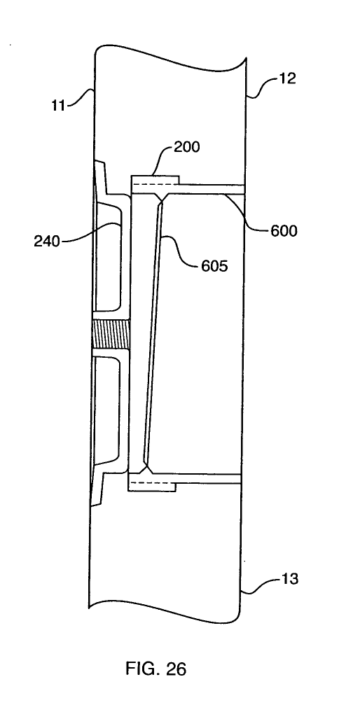

According to a further embodiment, the present invention features in insert 200, FIG. 26, having an integral molded skirt 600. The integral molded skirt 600 extends outwardly from the threaded region of the insert 200 and extends towards the inner surface of the concrete form, thereby preventing the concrete from entering the cavity formed by the insert 200 during the manufacturing process of the structure 13.

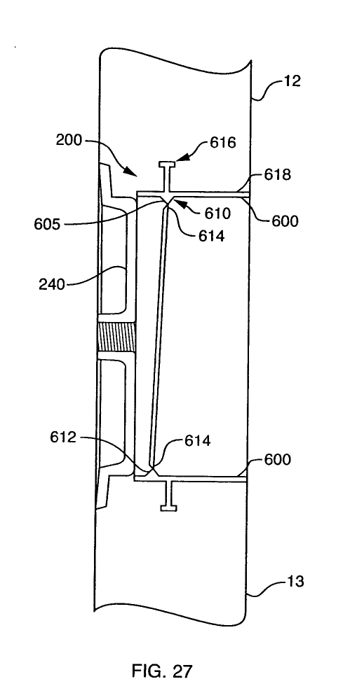

Optionally, the insert 200, FIG. 27, includes a knockout disk 610. The knockout disk 610 seals the cavity formed by the insert 200 when the insert 200 is not being used to form a connection, for example a connection with a pipe (not shown). The knockout disk 610 includes a region 612 that enable to the knockout disk 610 to be easily removed from the cavity of the insert 200. For example, the region 612 may include a circumferentially notched area 614. In the preferred embodiment, the knockout disc 610 is be located within the threaded region 605 of the insert 200, however, this is not a limitation unless otherwise specified in the claims. The knockout disk 610 may also be located anywhere within the insert 200, for example, within the skirt region 600.

A “T” shaped protrusion 616 optionally extends circumferentially outward from the outer surface 618 of the insert 200. During the manufacturing process of the structure 13, the concrete flows around the “T” shaped protrusion 616 forming a mechanical interlock with the concrete of the structure 13. This mechanical interlock aids in securing the insert 200 and preventing the insert 200 (which is preferably constructed from plastic) from moving relative to the structure 13.

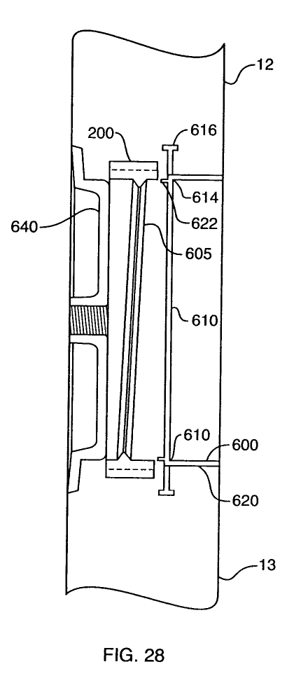

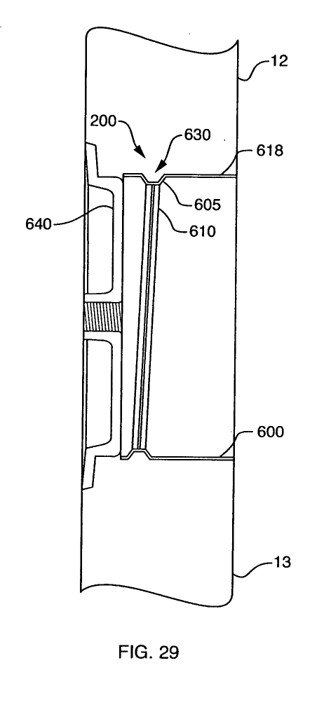

In an alternative embodiment, the insert 200, FIG. 28, is secured to a separate ring 620. The ring 620 is preferably manufactured from a soft plastic and the insert 200 is preferably manufactured from a hard plastic. While the ring 620 may be secured to the insert 200 in any manner known to those skilled in the art, the ring 620 preferably includes a region 622 sized and shaped to engage the insert 200 and form a snap fit connection with the insert 200. The ring 620 optionally includes a knockout disk insert 610 (preferably having a circumferentially notched area 614 as described above) and an integral skirt 600. A “T” shaped protrusion 616 may be included to form a mechanical interlock between the ring 620 and the concrete of the structure 13 as described above.

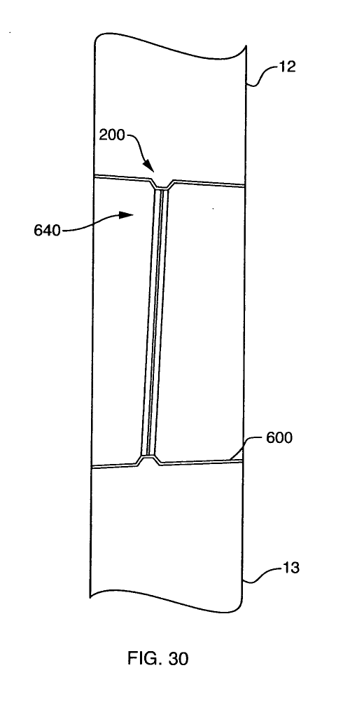

According to yet another embodiment, the present invention features an insert 200, FIG. 29, is manufactured from a thin, soft plastic. The outer surface 618 of the insert 200 includes a region 630 inversely corresponding to the threaded region 605. During the manufacturing process of the structure 13, the concrete flows around the outer surface 618 of the insert 200 and into the region 630. As a result, the concrete forms a threaded region corresponding to the threaded region 605 of the insert 200 thereby strengthening the threaded region 605 of the insert 200. This also enhances the longevity of the threaded region 605 by reducing or preventing the plastic of the threaded region 605 from creeping over time. The insert 200 also preferably includes an integral molded skirt 600 as described above and optionally includes a knockout disk 610. Additionally, the insert 200, FIG. 30, may have a generally tapered exterior and/or interior shape. The tapered shape enhances the connection between the insert 200 and the wall 12 when an adapter (not shown) is threaded in by creating a radial force urging the insert 200 against the wall 12.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

What is claimed is:

1. A modular connection system for use with a wall of a structure, said modular connection system comprising:
an insert defining a first cavity having a generally circular inner surface including a first threaded region, said insert further including an outer, exterior surface adapted to be secured within an aperture disposed within said wall of said structure.

2. The modular connection system as claimed in claim 1 wherein said first threaded region includes substantially only a single thread.

3. The modular connection system as claimed in claim 2 wherein said first threaded region includes a single thread extending approximately 350 degrees about said generally circular inner surface of said cavity.

4. The modular connection system as claimed in claim 1 wherein said exterior surface of said insert includes at least one protrusion.

5. The modular connection system as claimed in claim 4 wherein said at least one protrusion includes at least one dove-tail.

6. The modular connection system as claimed in claim 1 wherein said exterior surface of said insert includes at least one indentation.

7. The modular connection system as claimed in claim 1 further including an adapter having an exterior surface including a second threaded region disposed proximate a first end sized and shaped to releaseably engage with said first threaded of said insert, said adapter including a second cavity having a diameter at least as large as an internal diameter of a first pipe end.

8. The modular connection system as claimed in claim 7 wherein an interior surface of said cavity of said adapter includes at least one notch, said at least one notch adapted to engage an internal wrench.

9. The modular connection system as claimed in claim 7 wherein said adapter includes a circumferential protrusion extending generally outward from a second, generally opposite end of said adapter and generally perpendicular to a longitudinal axis of said adapter.

10. The modular connection system as claimed in claim 9 further including a gasket sized and shaped to fit between said circumferential protrusion of said adapter and said wall of said structure.

11. The modular connection system as claimed in claim 10 further including a generally circular shaped cap for sealing said second cavity, said cap including a circumferential lip extending generally inward from an outer lip region of said cap and generally perpendicular to a longitudinal axis of said cap, wherein at least a portion of said circumferential lip is sized and shaped to fit between said circumferential protrusion of said adapter and an exterior surface of said wall of said support.

12. The modular connection system as claimed in claim 11 wherein said cap further includes a central tab region adapted to form an opening sized and shaped to frictionally engage an outer surface of said first pipe end.

13. The modular connection system as claimed in claim 7 further including at least one grommet circumferentially disposed along said second cavity, said at least one grommet sized and shaped to frictionally engage an outer surface of said first pipe end.

14. The modular connection system as claimed in claim 7 further including a boot having a first end adapted to be secured to said first pipe end and a second end having means for connecting said second end of said boot to a second end of said adapter.

15. The modular connection system as claimed in claim 14 wherein said means for connecting said second end of said boot to said adapter includes at least one protrusion disposed about said outer, exterior surface proximate said second end of said adapter and at least one indentation disposed on an inner surface proximate said second end of said boot, wherein said at least one protrusion and said at least one indentation are adapted to matedly engage with each other when said second end of said boot is arranged about said second end of said adapter.

16. The modular connection system as claimed in claim 15 further including an adhesive disposed between said at least one protrusion and said at least one indentation when said at least one protrusion and said at least one indentation are connected.

17. The modular connection system as claimed in claim 14 wherein said means for connecting said second end of said boot to said adapter includes at least one indentation disposed about said outer, exterior surface proximate said second end of said adapter and at least one protrusion disposed on an inner surface proximate said second end of said boot, wherein said at least one protrusion and said at least one indentation are adapted to matedly engage with each other when said second end of said boot is arranged about said second end of said adapter.

18. The modular connection system as claimed in claim 17 further including at least one press fit band sized and shaped to fit about an exterior surface of said boot proximate said at least one protrusion and said at least one indentation, wherein said at least one press fit band biases said boot against exterior surface of said adapter.

19. The modular connection system as claimed in claim 14 wherein said means for connecting said second end of said boot to said adapter includes a circumferential protrusion extending generally outward from a second end of said adapter and generally perpendicular to a longitudinal axis of said adapter and a circumferential lip extending generally inward from a second end of said boot and generally perpendicular to a longitudinal axis of said boot, wherein at least a portion of said circumferential lip is sized and shaped to fit between said circumferential protrusion of said adapter and an exterior surface of said wall of said support.

20. The modular connection system as claimed in claim 19 further including a circumferential indentation disposed within said exterior surface of said wall of said support proximate said aperture, wherein said circumferential lip and said circumferential protrusion are sized and shaped to at least partially fit within said circumferential indentation.

21. The modular connection system as claimed in claim 1 further including a knockout, said knockout including a body having a generally circular outer surface sized and shaped to fit within said cavity of said insert, said body including an internal knockout membrane region and an exterior knockout membrane region having a protrusion extending generally outwardly beyond said internal knockout membrane region along a longitudinal axis of knockout.

22. The modular connection system as claimed in claim 21 wherein said knockout further includes means for engaging said cavity of said insert.

23. The modular connection system as claimed in claim 22 wherein said means for engaging said cavity of said insert includes at least one thread, said at least one thread engaging said at least one thread of said insert.

24. The modular connection system as claimed in claim 22 wherein said means for engaging said cavity of said insert includes a snap-fit connection.

25. The modular connection system as claimed in claim 22 wherein said means for engaging said cavity of said insert includes a friction-fit connection.

26. The modular connection system as claimed in claim 21 further including a mandrel, said mandrel including a threaded central region for mating with a concrete form and a shoulder region over which said insert is placed to form a snap-fit connection.

27. The modular connection system as claimed in claim 26 wherein said mandrel includes a slightly a slightly non-90 degree region that creates a corresponding slanted recess in said wall of said structure.

28. The modular connection system as claimed in claim 1 further including a mandrel and a knockout, said mandrel including a threaded central region for mating with a concrete form and a shoulder region over which said insert is placed to form a snap-fit connection, said knockout including at least one snap-fit finger having a protrusion disposed proximate a distal end, said at least one snap-fit finger arranged to extend through said first cavity of said insert and mate with an interior surface of said mandrel.

29. The modular connection system as claimed in claim 1 further including a knockout, said knockout including a membrane region sized and shaped to fit within said cavity of said insert proximate said first threaded region.

30. The modular connection system as claimed in claim 29 wherein said knockout further includes a generally circumferential notch disposed proximate an outer perimeter of said membrane region.

31. The modular connection system as claimed in claim 1 further including a generally cylindrical skirt extending along a longitudinal axis of said insert generally to said an outer, exterior surface of said wall of said structure, said skirt defining a third cavity having a diameter substantially equal to a diameter of said first cavity.

32. The modular connection system as claimed in claim 1 wherein said insert includes a generally soft plastic and wherein said outer, exterior surface of said insert includes at least one protrusion extending generally radially outwardly, said at least one protrusion having a generally “T” shape cross-section.

33. The modular connection system as claimed in claim 1 further including a ring adapted to be secured to a first end of said insert, said ring defining a fourth cavity having a diameter substantially equal to a diameter of said first cavity and including a generally cylindrical skirt extending along a longitudinal axis of said insert and said ring generally to said an outer, exterior surface of said wall of said structure.

34. The modular connection system as claimed in claim 33 further including a knockout, said knockout including a membrane region sized and shaped to fit within said fourth cavity of said ring.

35. The modular connection system as claimed in claim 34 wherein said knockout further includes a generally circumferential notch disposed proximate an outer perimeter of said membrane region.

36. The modular connection system as claimed in claim 35 wherein said ring further includes at least one protrusion extending generally radially outwardly, said at least one protrusion having a generally “T” shape cross-section.

37. The modular connection system as claimed in claim 1 wherein said insert includes a generally soft plastic, wherein said outer, exterior surface includes a region having a contour generally inversely corresponding to said first threaded region.

38. The modular connection system as claimed in claim 37 wherein said first cavity of said insert includes a generally conical inner surface.

39. The modular connection system as claimed in claim 38 wherein said outer, exterior surface of said insert includes a generally conical shape.

40. A modular connection kit for use with a wall of a structure, said modular connection kit comprising:
an insert having an outer, exterior surface adapted to be secured within an aperture disposed within said wall of said support, said insert forming a first cavity having a first threaded region; and
an adapter including a first end region having a second threaded region sized and shaped to engage with said first threaded region, a second end region having means for engaging with a first pipe end, and a second cavity having a diameter at least as large as a diameter of said first cavity.

41. The modular connection kit as claimed in claim 40 further including a boot, wherein said means for engaging with said first pipe end includes a circumferential shoulder region extending generally outward from a second end of said adapter and generally perpendicular to a longitudinal axis of said adapter and a circumferential lip extending generally inward from a second end of said boot and generally perpendicular to a longitudinal axis of said boot, wherein at least a portion of said circumferential lip is sized and shaped to fit between said circumferential shoulder region of said adapter and an exterior surface of said wall of said support.

42. The modular connection kit as claimed in claim 41 further including a circumferential indentation disposed within said exterior surface of said wall of said support proximate said aperture, wherein said circumferential lip and said circumferential shoulder region are sized and shaped to at least partially fit within said circumferential indentation.

43. The modular connection kit as claimed in claim 40 further including a knockout, said knockout, said knockout including a body having a generally circular outer surface sized and shaped to fit within said cavity of said insert and including means for engaging with said cavity, said body including an internal knockout membrane region and an exterior knockout membrane region having a protrusion extending generally outwardly beyond said internal knockout membrane region along a longitudinal axis of knockout.

44. The modular connection kit as claimed in claim 40 wherein said means for engaging with said first pipe end includes a circumferential grommet disposed within said second cavity of said adapter, said circumferential grommet adapted to frictionally engage with said first pipe end.

45. A modular connection kit for use with a wall of a structure, said modular connection kit comprising:
a generally tubular shaped insert, said insert including means for securing said insert within an aperture disposed within said wall of said support and defining a first cavity; and
a generally tubular shaped adapter including a second cavity, means for securing a first end region said adapter to a first end of said insert, and means for engaging with a first pipe end, whereby when connected said insert and said adapter form a passageway having a diameter at least as large as a diameter of said first cavity.

46. The modular connection kit as claimed in claim 45 wherein said means for securing said first end region said adapter to said first end of said insert includes a first and a second threaded region disposed proximate said first end region said adapter and said first end of said insert, respectively.

47. The modular connection kit as claimed in claim 46 wherein said first threaded region includes substantially only a single thread extending approximately 350 degrees.

48. The modular connection kit as claimed in claim 45 wherein said means for engaging with said first pipe end includes a boot adapted to be secured to a second end region of said adapter.

49. The modular connection kit as claimed in claim 48 further including a circumferential shoulder region extending generally outward from a second end of said adapter and generally perpendicular to a longitudinal axis of said adapter and a circumferential lip extending generally inward from a second end of said boot and generally perpendicular to a longitudinal axis of said boot, wherein at least a portion of said circumferential lip is sized and shaped to fit between said circumferential shoulder region of said adapter and an exterior surface of said wall of said support.

50. The modular connection kit as claimed in claim 45 further including a knockout, said knockout including a body having a generally circular outer surface sized and shaped to fit within said first cavity, said body including an internal knockout membrane region and an exterior knockout membrane region having a protrusion extending generally outwardly beyond said internal knockout membrane region along a longitudinal axis of knockout.
